(19) United States
(12) Patent Application Publication
(10) Pub. No.: US 2005/0195220 A1
(43) Pub. Date: Sep. 8, 2005

(54) Compositing with clip-to-self functionality without using a shape channel

(75) Inventors: Craig William Northway, West Ryde (AU); Craig Matthew Brown, Harbord (AU); Alexander Vincent Danilo, Harbord (AU); Philip Doak Armstrong, Sydney (AU); Matthew James Allen, North Ryde (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/052,839

(22) Filed: Feb. 9, 2005

(30) Foreign Application Priority Data
Feb. 13, 2004 (AU) 2004900710
Apr. 20, 2004 (AU) 2004902101

(51) Int. Cl. G06T 15/40

(52) U.S. Cl. 345/620

(57) ABSTRACT

A method (1000) of compositing a group of graphical objects (B). The method (1000) forms the group of objects (B) in a temporary buffer (W). For each object (C, D) in the group of objects (B), a corresponding clipping path is provided. A resultant clipping path (Z) defined by a union of the clipping paths is calculated. The group of objects from the temporary buffer (W) is composited to a main buffer (V) through the resultant clipping path (Z).

### CROSS-REFERENCE TO RELATED PATENT APPLICATIONS

This application claims the right of priority under 35 U.S.C. § 119 based on Australian Patent Application No. 2004900710, filed 13 Feb. 2004, and Australian Patent Application No. 2004902101, filed 20 Apr. 2004, which are incorporated by reference herein in their entirety as if fully set forth herein.

### FIELD OF THE INVENTION

The present invention relates generally to image creation and, in particular, to the rendering of overlapping groups of graphical objects.

### BACKGROUND

A graphical object is a description of certain features such as lines, curves, text, colours and the like that make up an image entity, this being generally known as vector graphics. An image may be formed by a single object or a combination of multiple objects having a defined interaction. Graphical objects are converted into a bitmap image by rendering them one after another, typically into a memory or onto a page thus forming the bitmap image.

Some types of objects that may be combined into an output bitmap include:
shapes, (e.g., lines, curves, fill and stroke colours);
text;
images; and
effects (e.g. a blur or a lighting effect).

It is common to group or combine two or more of the above objects. Once grouped, the objects may be treated as a single source object. This may done for a number of reasons:
to apply an effect to a group of objects (eg. blur all the items in a group or make the whole group partially transparent);
to reuse a group of objects; or
to transform objects as a group (eg. the objects in a group may be animated as a single object and moved across a page together).

When rendering objects onto a page, either in memory or direct to a printable page, it is most common to render the objects onto the page sequentially. Where one partially transparent object sits on top of another object, the colour information of both objects is combined to produce the final pixel colour result. This combining is known as compositing and can be used to produce a variety of effects. For example, one of effects of compositing is the appearance of looking at an image through tinted glass.

While it is common to place objects on top of each other as described above, it is sometimes useful to use different mathematical techniques to combine objects. For example, it might be useful for one object to be used as a shadow on another object, or to intersect with another object. Two techniques are commonly used for combining objects. A first is that described in the seminal paper “Compositing Digital Images”, T. Porter, T. Duff, Computer Graphics, Vol. 18, No. 3, July 1984 pp 253-259, which described what is now commonly known as “Porter & Duff compositing”. Another compositing technique is that called “Adobe® Blending Modes” as described in the Portable Document Format (PDF) specification published by Adobe Systems Incorporated.

In most situations, when each object is placed onto a page to form a resultant image, the object adds to the resultant image. For some operations, such as the Porter & Duff “in” operation, the new object being placed onto the page is intersected with the objects already on the page. This can result in a final image that contains less data than before the new object was drawn. Consequently, compositing an object onto an image using certain operations removes data from the image.

For most drawing operations, an image is only affected within the extent of the object being drawn. For example, if a circle is drawn on a background with one of such drawing operations, nothing outside the circle is modified. For some operations, such as the Porter & Duff “in” operation, the background outside the extent of such a circle is cleared. While it is desirable to perform the Porter & Duff “in” operation within an object, it is not always desirable to have this extra side-effect that the background is cleared outside the extent of the object being drawn.

Some drawing systems, such as Java2D manufactured by Sun Microsystems, Inc. may turn off this side-effect. When a single object is composited onto the background, systems such as Java2D can determine which pixels are within the extent of the object and which are not, and thus can determine which output image pixels to clear, and which not to touch, if the side-effect is turned off. Some drawing systems, such as Microsoft Windows Graphics Device Interface (GDI), also avoid this side-effect by allowing compositing (using the equivalent of the Porter & Duff “over” operation) of an object over a background through a defined clipping path. However, most conventional drawing systems such as the Microsoft Windows GDI, do not support the remaining Porter & Duff compositing operations, or do not do so in conjunction with a defined clipping path.

Furthermore, when a number of objects are combined together into a group, most conventional drawing systems find it difficult to determine which areas (ie. those pixels) that are within the group of objects and which are not, without storing a bitmap representation (ie. a “shape channel”) of the extent of the combined objects.

Thus a need clearly exists for an improved method of compositing graphical objects.

### SUMMARY

It is an object of the present invention to substantially overcome, or at least ameliorate, one or more disadvantages of existing arrangements.

Disclosed are arrangements which seek to address the above problems by forming a clipping channel corresponding to the shape of the group of objects.

In one arrangement, a compositing operation is changed and the new compositing operation is performed on an existing temporary buffer instead of a main buffer. Such an arrangement avoids the need of a composite result buffer and reduces memory usage and copying operations.

According to one aspect of the present disclosure, there is provided a method of compositing a group of graphical objects onto a main buffer using a specified compositing operation, said method comprising the steps of:
forming said group of objects in a temporary buffer;
providing, for each object in said group of objects, a corresponding clipping path;
calculating a resultant clipping path defined by a union of said clipping paths;
compositing said group of objects from said temporary buffer to a main buffer through said resultant clipping path using said specified compositing operation.

According to another aspect of the present disclosure, there is provided an apparatus for compositing a group of graphical objects, said apparatus comprising:
object forming means for forming said group of objects in a temporary buffer;
clipping path providing means for providing, for each object in said group of objects, a corresponding clipping path;
calculating means for calculating a resultant clipping path defined by a union of said clipping paths;
compositing means for compositing said group of objects from said temporary buffer to a main buffer through said resultant clipping path.

According to still another aspect of the present disclosure, there is provided a computer readable medium, having a program recorded thereon, where the program is configured to make a computer execute a procedure to composite a group of graphical objects, said method comprising the steps of:
code for forming said group of objects in a temporary buffer;
code for providing, for each object in said group of objects, a corresponding clipping path;
code for calculating a resultant clipping path defined by a union of said clipping paths;
code for compositing said group of objects from said temporary buffer to a main buffer through said resultant clipping path.

According to still another aspect of the present disclosure, there is provided a computer program for compositing a group of graphical objects, said program comprising:
code for forming said group of objects in a temporary buffer;
code for providing, for each object in said group of objects, a corresponding clipping path;
code for calculating a resultant clipping path defined by a union of said clipping paths;
code for compositing said group of objects from said temporary buffer to a main buffer through said resultant clipping path.

According to still another aspect of the present disclosure, there is provided a method of compositing a group of graphical objects onto a main buffer using a specified compositing operation, said method comprising the steps of:
forming said group of objects in a temporary buffer;
providing, for each object in said group of objects, a corresponding clipping path;
calculating a resultant clipping path defined by a union of said clipping paths;
compositing said main buffer onto said group of objects in said temporary buffer using a compositing operation that is complementary to said specified compositing operation; and
copying said temporary buffer to said main buffer through said resultant clipping path.

According to still another aspect of the present disclosure, there is provided a method of compositing an opaque graphical object onto a second opaque graphical object using a specified compositing operation so as to preserve unchanged pixel values outside the boundary of said opaque graphical object, said method comprising at least the step of compositing said opaque graphical object onto said second graphical object using a second compositing operation that is derived from said specified compositing operation.

According to still another aspect of the present disclosure, there is provided an apparatus for compositing a group of graphical objects onto a main buffer using a specified compositing operation, said apparatus comprising:
object forming means for forming said group of objects in a temporary buffer;
clipping path providing means for providing, for each object in said group of objects, a corresponding clipping path;
calulating means for calculating a resultant clipping path defined by a union of said clipping paths;
compositing means for compositing said main buffer onto said group of objects in said temporary buffer using a compositing operation that is complementary to said specified compositing operation; and
copying means for copying said temporary buffer to said main buffer through said resultant clipping path.

According to still another aspect of the present disclosure, there is provided a computer readable medium, having a program recorded thereon, where the program is configured to make a computer execute a procedure to composite a group of graphical objects onto a main buffer using a specified compositing operation, said program comprising:
code for forming said group of objects in a temporary buffer;
code for providing, for each object in said group of objects, a corresponding clipping path;
code for calculating a resultant clipping path defined by a union of said clipping paths;
code for compositing said main buffer onto said group of objects in said temporary buffer using a compositing operation that is complementary to said specified compositing operation; and
code for copying said temporary buffer to said main buffer through said resultant clipping path.

According to still another aspect of the present disclosure, there is provided a computer program for compositing a group of graphical objects onto a main buffer using a specified compositing operation, said program comprising:
code for forming said group of objects in a temporary buffer;
code for providing, for each object in said group of objects, a corresponding clipping path;
code for calculating a resultant clipping path defined by a union of said clipping paths;
code for compositing said main buffer onto said group of objects in said temporary buffer using a compositing operation that is complementary to said specified compositing operation; and
code for copying said temporary buffer to said main buffer through said resultant clipping path.

According to still another aspect of the present disclosure, there is provided a method of compositing a graphical object onto a second graphical object using a specified compositing operation through a clipping path, said method comprising at least the steps of:
compositing said second graphical object onto a buffer containing said graphical object using a second compositing operation that is complementary to said specified compositing operation; and
copying the contents of said buffer onto a second buffer containing said second graphical object through said clipping path.

According to still another aspect of the present disclosure, there is provided an apparatus for compositing a graphical object onto a second graphical object using a specified compositing operation through a clipping path, said apparatus comprising:
compositing means for compositing said second graphical object onto a buffer containing said graphical object using a second compositing operation that is complementary to said specified compositing operation; and
copying means for copying the contents of said buffer onto a second buffer containing said second graphical object through said clipping path.

According to still another aspect of the present disclosure, there is provided a computer readable medium, having a program recorded thereon, where the program is configured to make a computer execute a procedure to composite a graphical object onto a second graphical object using a specified compositing operation through a clipping path, said program comprising:
code for compositing said second graphical object onto a buffer containing said graphical object using a second compositing operation that is complementary to said specified compositing operation; and
code for copying the contents of said buffer onto a second buffer containing said second graphical object through said clipping path.

According to still another aspect of the present disclosure, there is provided a computer program for compositing a graphical object onto a second graphical object using a specified compositing operation through a clipping path, said program comprising:
code for compositing said second graphical object onto a buffer containing said graphical object using a second compositing operation that is complementary to said specified compositing operation; and
code for copying the contents of said buffer onto a second buffer containing said second graphical object through said clipping path.

Other aspects of the invention are also disclosed.

### BRIEF DESCRIPTION OF THE DRAWINGS

One or more embodiments of the present invention will now be described with reference to the drawings, in which:

FIG. 1 shows an initial object in a main buffer;

FIG. 2 shows a temporary buffer;

FIG. 3 shows a further object rendered to the temporary buffer;

FIG. 4 shows a clipping path associated with the further object of FIG. 3;

FIG. 5 shows an additional object rendered to the temporary buffer;

FIG. 6 shows a clipping path associated with the additional object of FIG. 5;

FIG. 7 shows a union of the clipping paths of FIGS. 4 and 6;

FIG. 8 shows the result of compositing the main buffer of FIG. 1 onto the temporary buffer of FIG. 5;

FIG. 9 shows a final rendering of the objects of FIG. 5 to that of FIG. 1 based upon the clipping path of FIG. 7;

FIG. 10 is a flow diagram showing a method of compositing objects;

FIG. 11 is a schematic block diagram of a general-purpose computer upon which arrangements described can be practiced;

FIG. 12 illustrates various Porter & Duff compositing operations implemented without and with clip-to-self functionality;

FIG. 13 illustrates the various Porter & Duff compositing operations of FIG. 12 on a non-opaque destination object implemented without and with clip-to-self functionality;

FIG. 14 illustrates simple Porter & Duff compositing with opaque objects.

FIG. 15 is a flow diagram showing another method of compositing objects;

FIG. 16 shows the result of compositing the main buffer of FIG. 1 onto the temporary buffer of FIG. 5, using the method of FIG. 15; and

FIG. 17 is a flow diagram showing a method of performing clip-to-self compositing, as executed in the method of FIG. 15.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that below relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

For some compositing operations, such as the Porter & Duff “in” operation, the background (i.e., the area outside the boundaries of a source object being drawn) is cleared. Such an effect is not always desirable. One method of avoiding this effect is to clip a compositing operation within the boundaries of the source object. This is termed ‘clip-to-self’ compositing. Most conventional drawing systems, such as the Microsoft Windows GDI discussed above are not able to perform clip-to-self compositing with fewer than three buffers (i.e., a “source” buffer, a “background” buffer and a “composite result” buffer), when required to support the entire set of Porter & Duff operations. In such a conventional drawing system, to draw a source object, the composite result buffer is initialised to the background buffer. A corresponding Porter & Duff compositing operation is then performed on the contents of the source buffer (eg. an object) and the contents of the composite result buffer. The composite result buffer is then copied to the background buffer using the “src” operation through a clip path. Therefore, to draw the source object, additional memory is required for the composite result buffer. Further, a copy operation of the background buffer into the composite result buffer is required for each composite operation.

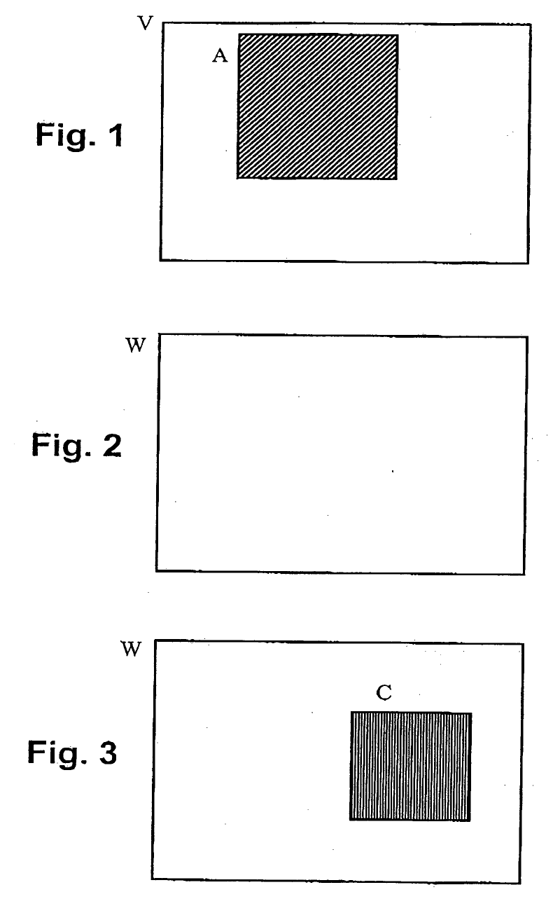

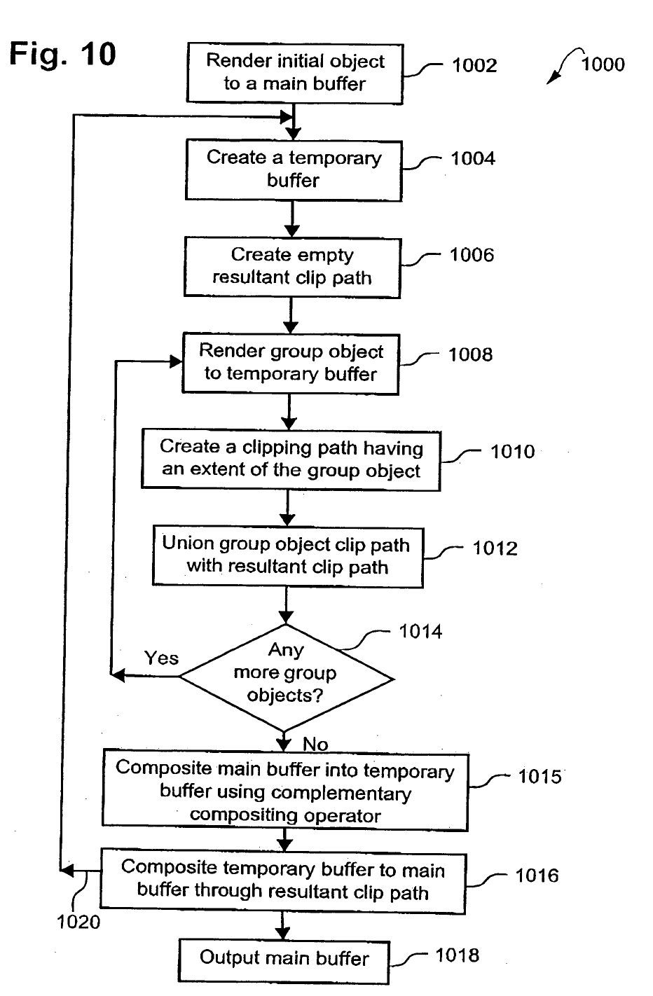

A method 1000 (see FIG. 10) of compositing objects is described below with reference to FIGS. 1 to 14. The method 1000 may be used to composite a single object, or a group of objects, with a background using a specified compositing operation. The method 1000 avoids the need of a composite result buffer and reduces memory usage and copying operations.

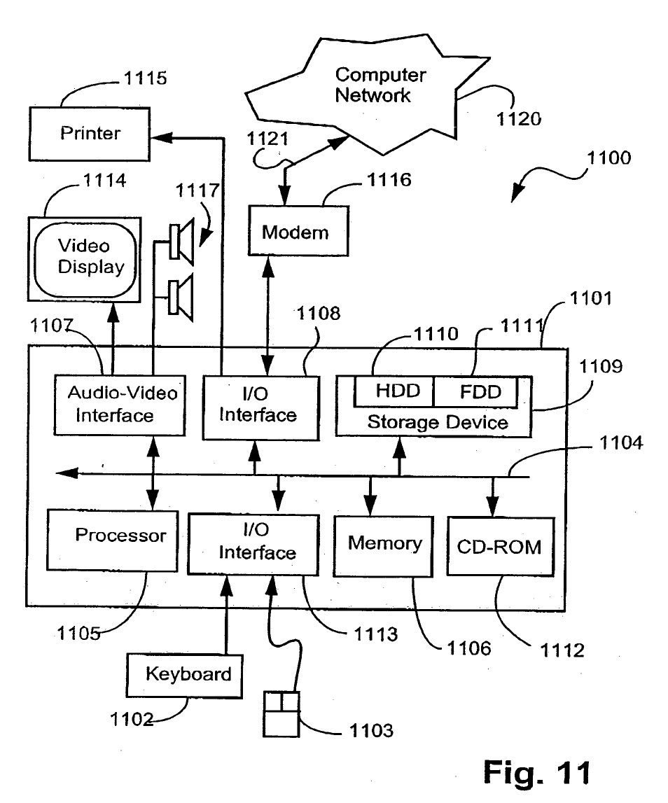

The method 1000 may be practiced using a general-purpose computer system 1100, such as that shown in FIG. 11 wherein the processes depicted in FIGS. 1 to 10 may be implemented as software, such as an application program executing within the computer system 1100. In particular, the steps of the method 1000 may be effected by instructions in the software that are carried out by the computer. The instructions may be formed as one or more code modules, each for performing one or more particular tasks. The software may also be divided into two separate parts, in which a first part performs the compositing methods and a second part manages a user interface between the first part and the user. The software may be stored in a computer readable medium, including the storage devices described below, for example. The software may be loaded into the computer from the computer readable medium, and then executed by the computer. A computer readable medium having such software or computer program recorded on it is a computer program product. The use of the computer program product in the computer preferably effects an advantageous apparatus for compositing objects.

The computer system 1100 is formed by a computer module 1101, input devices such as a keyboard 1102 and mouse 1103, output devices including a printer 1115, a display device 1114 and loudspeakers 1117. A Modulator-Demodulator (Modem) transceiver device 1116 is used by the computer module 1101 for communicating to and from a communications network 1120, for example connectable via a telephone line 1121 or other functional medium. The modem 1116 may be used to obtain access to the Internet, and other network systems, such as a Local Area Network (LAN) or a Wide Area Network (WAN), and may be incorporated into the computer module 1101 in some implementations.

The computer module 1101 typically includes at least one processor unit 1105, and a memory unit 1106, for example formed from semiconductor random access memory (RAM) and read only memory (ROM). The module 1101 also includes an number of input/output (I/O) interfaces including an audio-video interface 1107 that couples to the video display 1114 and loudspeakers 1117, an I/O interface 1113 for the keyboard 1102 and mouse 1103 and optionally a joystick (not illustrated), and an interface 1108 for the modem 1116 and printer 1115. In some implementations, the modem 1116 may be incorporated within the computer module 1101, for example within the interface 1108. A storage device 1109 is provided and typically includes a hard disk drive 1110 and a floppy disk drive 1111. A magnetic tape drive (not illustrated) may also be used. A CD-ROM drive 1112 is typically provided as a non-volatile source of data. The components 1105 to 1113 of the computer module 1101, typically communicate via an interconnected bus 1104 and in a manner which results in a conventional mode of operation of the computer system 1100 known to those in the relevant art. Examples of computers on which the described arrangements can be practised include IBM-PC's and compatibles, Sun Sparcstations or alike computer systems evolved therefrom.

Typically, the application program is resident on the hard disk drive 1110 and read and controlled in its execution by the processor 1105. Intermediate storage of the program and any data fetched from the network 1120 may be accomplished using the semiconductor memory 1106, possibly in concert with the hard disk drive 1110. In some instances, the application program may be supplied to the user encoded on a CD-ROM or floppy disk and read via the corresponding drive 1112 or 1111, or alternatively may be read by the user from the network 1120 via the modem device 1116. Still further, the software can also be loaded into the computer system 1100 from other computer readable media. The term “computer readable medium” as used herein refers to any storage or transmission medium that participates in providing instructions and/or data to the computer system 1100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1101. Examples of transmission media include radio or infra-red transmission channels as well as a network connection to another computer or networked device, and the Internet or Intranets including e-mail transmissions and information recorded on Websites and the like.

The method 1000 may be implemented as the application program discussed above, which typically would form a component or sub-program of a larger application such as a desktop publishing system or the like. The method 1000 will be described below by way of example. In the example, the method 1000 operates upon three objects, which include an initial object A seen in FIG. 1 and a group of objects B seen in FIG. 5. The group of objects B is formed of a first group object C and a second group object D.

Initially, in step 1002, the initial object A is drawn (ie. rendered) onto a background in a main image buffer V, as shown in FIG. 1. The step 1002 is exemplary, as the buffer V may be empty or may contain the results of previous compositing or other operations. The buffer V may be formed in the memory 1106, but where capacity is limited may in part or whole be formed in the HDD 1110. Rendering is performed by the processor 1105 interpreting the description of the object A according to a predetermined language and outputting pixel colour values to the buffer V. The background may, or may not comprise image elements. In the present example, the objects A, C and D are each rectangles, for ease of illustration. However, any regular or arbitrary shape may be used, as well as text or an image.

In step 1004, as shown in FIG. 2, a temporary buffer W is created into which the group of objects B is to be rendered as seen in FIG. 5. The buffer W is formed in a fashion akin to that of the buffer V. The following step 1006 creates an empty ‘resultant clipping path’ which, after subsequent operations, is to become the resultant group clipping path. A clipping path, such as the resultant clipping path, may be represented as an array of edges. An edge may be described by start coordinates (start_x, start_y) and one or more segment descriptions. Each segment description includes a memory address pointing to a next segment in the edge and a finish segment used to terminate the edge. The segments of an edge are contiguous in the sense the starting point of each segment is coincident with the end point of a previous segment. A straight-line segment is described by horizontal and vertical differences (Dx, Dy) between the start and end point of the segment. The resultant clipping path represented as an array of edges may be stored in memory 1106 and/or HDD 1110. The clipping path may be used to determine the pixels modified when performing rendering or compositing operations.

Step 1008, which follows, operates to render the first group object C into the buffer W, as seen in FIG. 3.

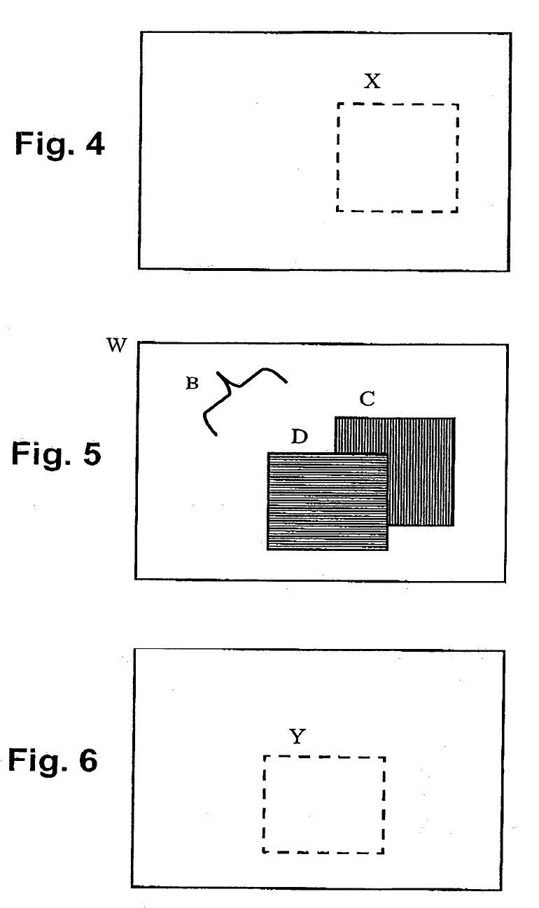

As seen in FIG. 4, step 1010 operates to create a clipping path X corresponding to the extent of the object C. The clipping path X is preferably a simple outline path, i.e. a single continuous path with uniform orientation and a non-zero winding rule. The path X shown in FIG. 4 is of this kind. The clipping path X may be stored in memory 1106.

Step 1012 then performs a union between the clipping path formed in step 1010 and the (initially empty) resultant clipping path of step 1006. The union between the clipping path formed in step 1010 and the resultant clipping path of step 1006 may be determined by concatenating the edge arrays describing each path. The result of the union of step 1012 may be stored as the resultant clipping path in memory 1106.

Step 1014 then tests to determine if there are any more group objects to be processed. If so, control returns to step 1008. In the present example, step 1008 on a second pass operates to render the group object D, as shown in FIG. 5, to the temporary buffer W. Step 1010 then creates a clipping path Y, in memory 1106, corresponding to the extent of the group object D. This is seen in FIG. 6.

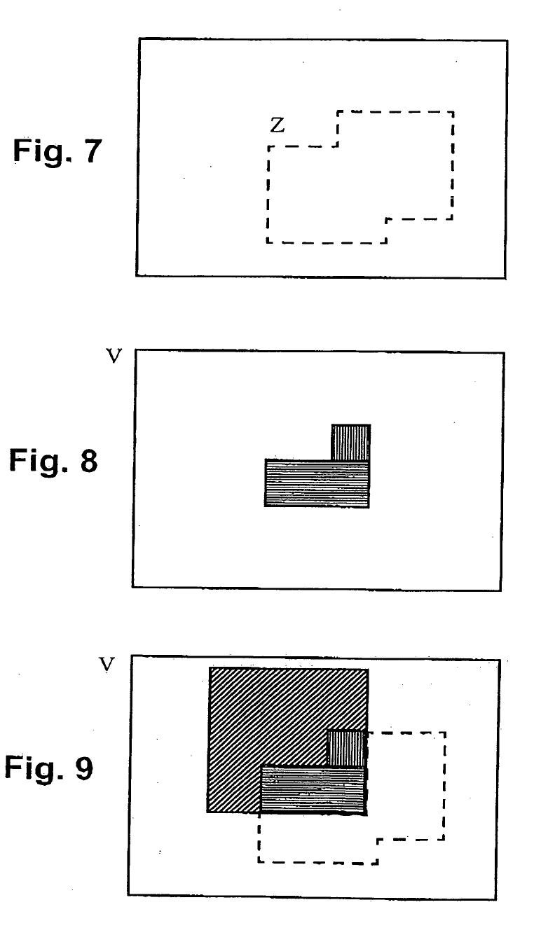

Step 1012 then operates to create a union between the clipping paths X and Y. In the present example this defines a clipping path Z in memory 1106, representing the outline of the union of extents of the objects C and D, as seen in FIG. 7. The clipping path Z is stored as the resultant clipping path in memory 1106.

Step 1014 then again tests for the presence of more group objects. In the present example there are none and control proceeds to step 1015.

Steps 1010 and 1012, in an alternative arrangement, may precede step 1008, so step 1014 loops back to step 1010, followed by steps 1012 and 1008, and then step 1014 again.

As will now be described, the following steps 1015 and 1016 perform clip-to-self compositing on the main buffer V and the temporary buffer W. Conventionally, to perform such clip-to-self compositing a Porter & Duff source operand (e.g., one or more objects in the temporary buffer W) is composited with a Porter & Duff destination operand (e.g., the background in the main buffer V) through the resultant clipping path stored in memory 1106 using a specified Porter & Duff operation. However, conventional rendering systems such as Windows GDI, as previously discussed, require another buffer (i.e., a composite result buffer) in order to support the separate compositing and clipping steps.

In the method 1000, as will be described in more detail below, step 1015 reverses the Porter & Duff operands to be composited and selects a complementary Porter & Duff operation to composite the reversed operands. The result of the compositing operation is substantially equivalent to compositing the original operands in the manner described in the paragraph directly above. However, in the method 1000, the composite result buffer is not required to support the separate compositing and clipping steps.

At step 1015 a Porter & Duff compositing operation is performed with the contents of the main buffer V (i.e., background) as the source operand and the contents of the temporary buffer W (i.e., the group of objects B) as the destination operand. Thus, the temporary buffer W is modified to contain the result of the Porter & Duff compositing operation. The Porter & Duff compositing operation performed at step 1015 is the complement of an original clip-to-self compositing operation specified to composite the contents of the main buffer V (i.e., background) and the contents of the temporary buffer W (i.e., the group of objects B). For example, as shown in Table 1 below, if the specified clip-to-self compositing operation is “src” then the corresponding operation “dst” under the “complementary” column from Table 1 is selected to composite the reversed operands at step 1015.

TABLE 1

| Specified | Complementary |
|---|---|
| compositing operation | compositing operation |
| Clear | Clear |
| Src | Dst |
| Dst | Src |
| Over | Rover |
| Rover | Over |
| In | Rin |
| Rin | In |
| Out | Rout |
| Rout | Out |
| Atop | Ratop |
| Ratop | Atop |
| Xor | Xor |

For the present example, the specified clip-to-self operation is the Porter & Duff “in” operation which will be complemented to operation “rin” at step 1015 using Table 1.

FIG. 8 shows the state of temporary buffer W after performing the complementary compositing operation in step 1015 according to the present example.

Step 1016 then copies the contents of the temporary buffer W (i.e., the result of compositing operation 1015) onto the contents of the main buffer V (i.e., the objects A) but through the resultant clipping path Z. Thereby the background in regions outside of the resultant clipping path Z is unaffected by step 1016. As shown in FIG. 9, the composited result pixels replace the pixels of object A within the resultant clipping path Z, but object A is unaffected outside the resultant clipping path Z, which is shown as a dashed outline. If such operations conclude the image generation process, step 1018 may be implemented to output the contents of the main buffer V, as seen in FIG. 9, for display upon the video screen 1114 or for hard copy reproduction via the printer 1115. If further objects are to be composited, control may return via a path 1020 to step 1004, where the present content of the main buffer V may be construed as the initial object A.

The creating of the clipping path in step 1010 may be performed according to the following:
(a) for shapes and text, use the path defining the object as the clipping path;
(b) for stroked objects, convert the stroked path to a clipping path;
(c) for bitmap image objects, use the edge or bounds of the image; and
(d) for effects (eg. a blur), there exists a region in which the effect operates, and the bounds of this region is converted to the clipping path.

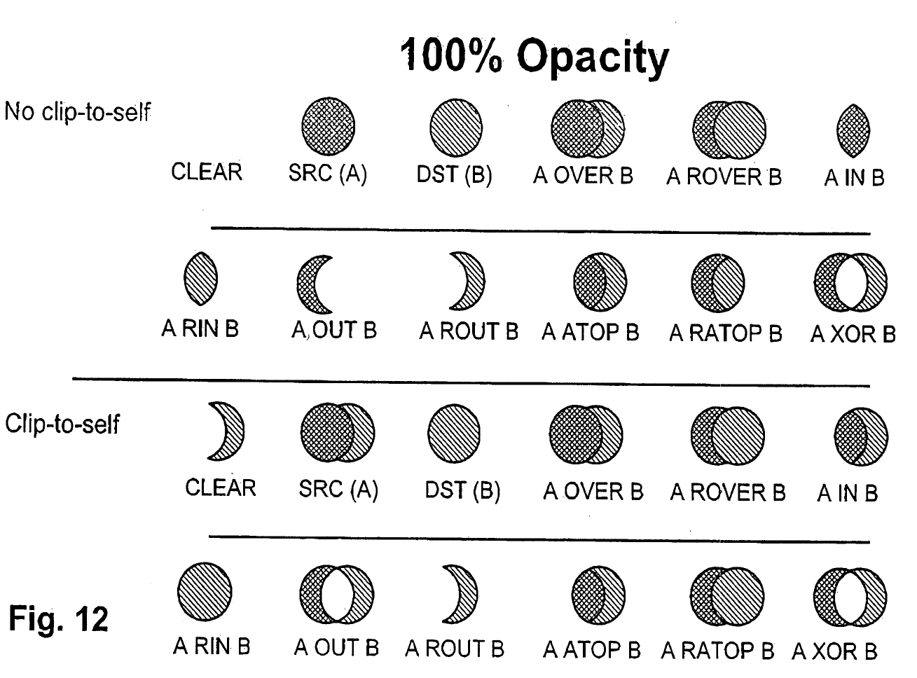

FIG. 12 illustrates various fundamental Porter & Duff compositing operations between opaque source (src, or A) and destination (dest, or B) operands. Please note that FIG. 12 does not show the complementary operations of Table 1. FIG. 12 also shows the result of the Porter & Duff operations on the same opaque objects using the method 1000, implementing clip-to-self functionality. Whilst the above example makes reference to the “in” operation, exemplified by “A in B” of FIG. 12, the principles discussed above may be used to address problems caused by other ones of the operations. Those operations include:
clear; A; A in B; A rin B; A out B; A ratop B

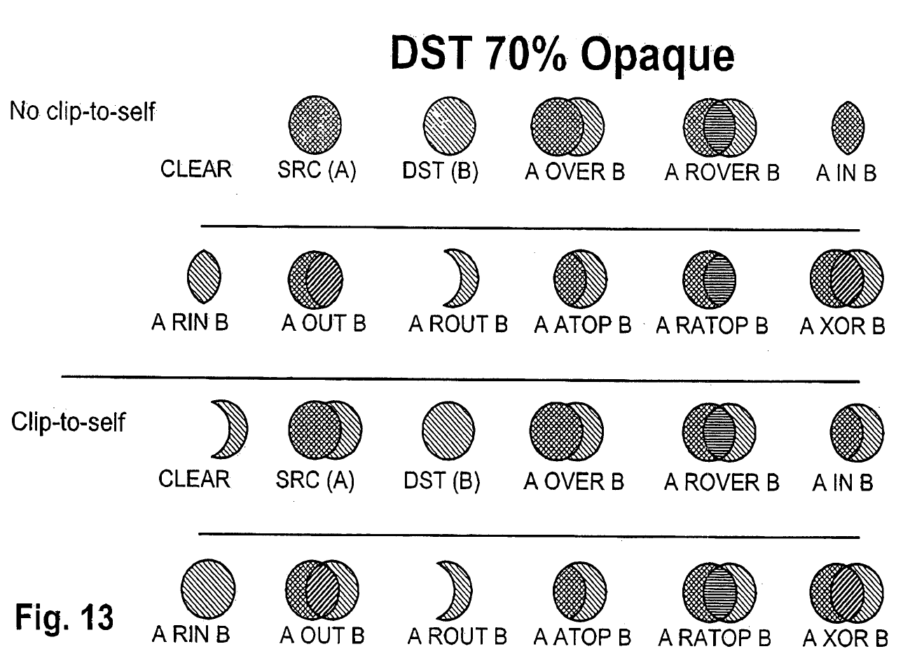

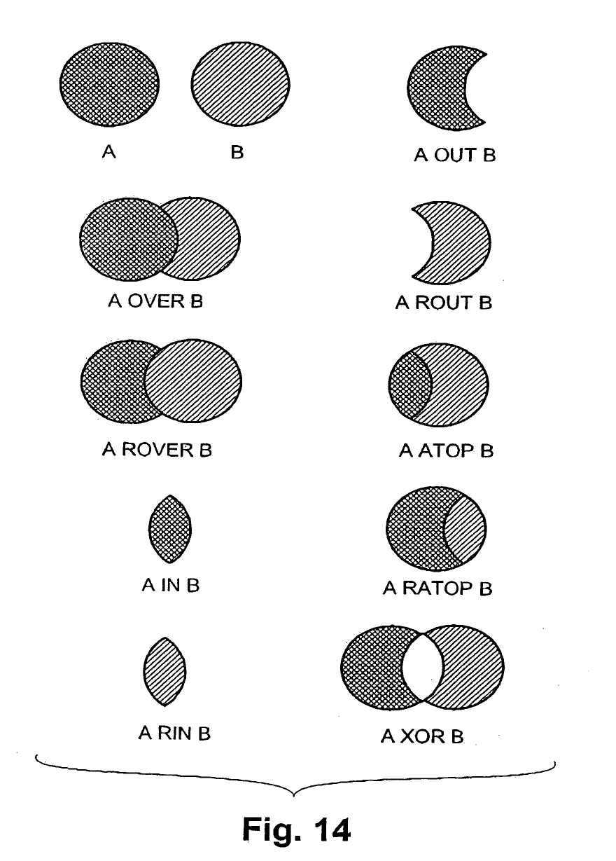

The methods disclosed above are equally applicable to the case where one or more of the group objects is not completely opaque. FIG. 14 shows Porter & Duff compositing operations for opaque objects. FIG. 13 shows the result of the Porter & Duff compositing operations, both without and with clip-to-self functionality, for the case where the destination operand (B) has 70% opacity. Moreover, the final compositing operation of step 1016 may also impart less than 100% opacity to the temporary buffer containing the group. The methods disclosed above are equally applicable in this case also.

The method 1000 described above may also be used to process a single object. In this instance, only one iteration of steps 1008 to 1014 of the method 1000 is required.

The method 1000 therefore affords an approach by which objects or groups of objects may be processed using full clip-to-self compositing functionality in a manner compatible with traditional compositing operations without the overhead of an additional buffer and copy per clip-to-self operation. This is achieved by reversing the operands to use the temporary buffer as the destination buffer and by changing the compositing operation to the complement of the specified compositing operation, as described above. Removing the overhead of using an additional temporary buffer for each clip-to-self operation and consequential copying may thus be achieved, and clip-to-self functionality for single or grouped objects may be implemented on systems lacking compositing functionality in conjunction with a clipping path. Using the method 1000, clip-to-self compositing may be performed without requiring the use of a shape channel or an additional memory buffer and corresponding copy operation overhead.

In another arrangement, if the source object (or all source objects in the case of a group of objects) and the destination object(s) are opaque, then the specified clip-to-self operation may be replaced by a simple Porter & Duff compositing operation. In this instance, there is no need to maintain a resultant clipping path and steps 1006, 1010, 1012, or 1016 are not required to be performed. Further, in step 1015 the temporary buffer W is composited onto the main buffer V using a simple Porter & Duff compositing operation as in the “Opaque clip-to-self compositing operation column” in the corresponding row of Table 2, below:

TABLE 2

| Specified | Opaque clip-to-self |
|---|---|
| compositing operation | compositing operation |
| Clear | Rout |
| Src | Over |
| Dst | Dst |
| Over | Over |
| Rover | Rover |
| In | Atop |
| Rin | Dst |
| Out | Xor |
| Rout | Rout |
| Atop | Atop |
| Ratop | Rover |
| Xor | Xor |

For example, if the specified clip-to-self operation is the Porter & Duff “in” operation for compositing where the source object (or all source objects in the case of a group) and the destination object(s) are opaque, the source object(s) and the destination object(s) will be composited using operation “atop” at step 1015 in accordance with Table 2.

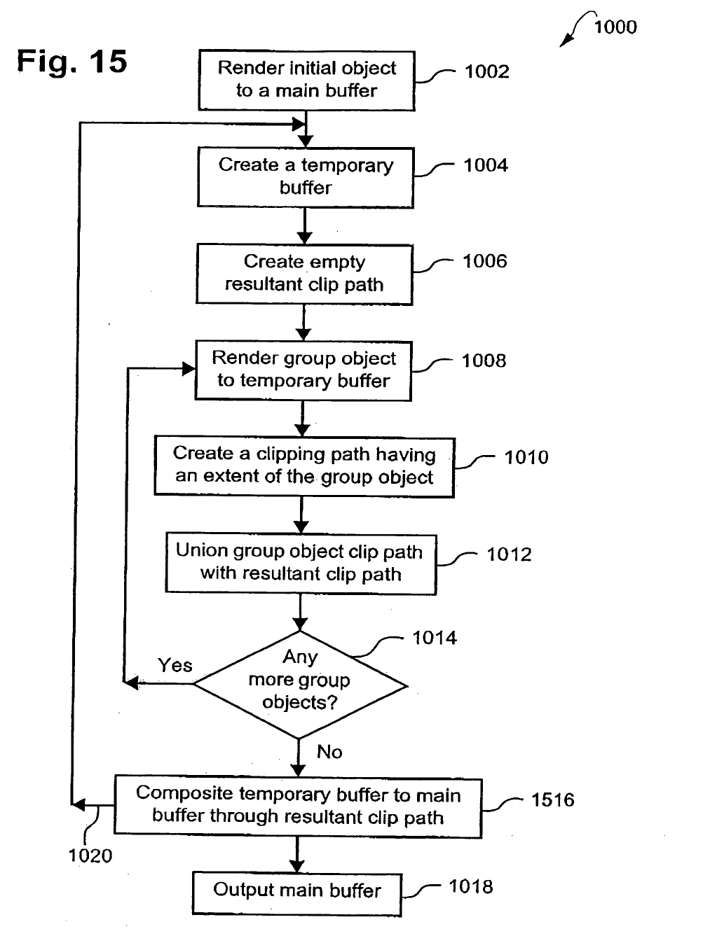

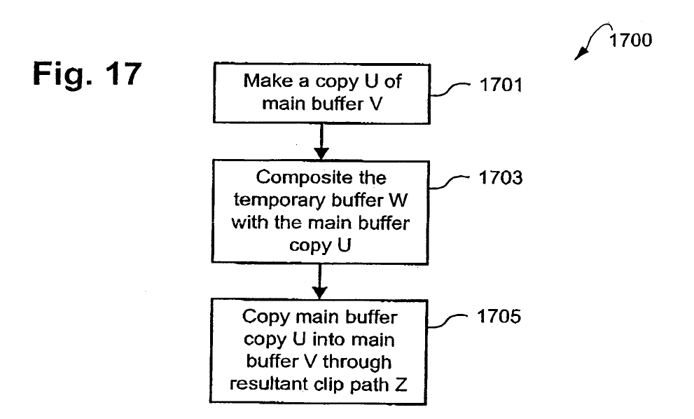

In still another arrangement of the method 1000, as shown in FIG. 15, steps 1015 and 1016 may be replaced with step 1516. At step 1516, the contents of the temporary buffer W are composited onto the contents of the main buffer V through the clipping path Z. A flow diagram showing a method 1700 of performing clip-to-self compositing, as executed at step 1516, will now be described with reference to FIG. 17.

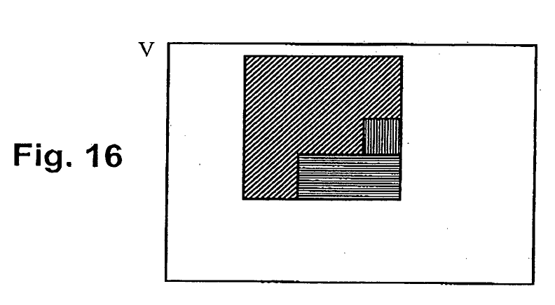

The method 1700 begins at step 1701, where the processor 1105 makes a copy U of the main buffer V (i.e., the objects A). At the next step 1703, the processor 1105 composites the contents of the temporary buffer W (i.e., the group of objects B) onto the contents of the main buffer copy U (i.e., the objects A) using a Porter & Duff compositing operation specified to composite the contents of the temporary buffer W. In the present example, the “src_in” operation, exemplified by “A in B” of FIG. 12, is used at step 1703. At the next step 1705, the processor 1105 copies the contents of the main buffer copy U, containing the group of objects B, onto the main buffer V through the resultant clipping path Z. The result of step 1516 is seen in FIG. 16 where the object group B is intersected with object A, but object A is unaffected outside the resultant clipping path Z. Again, the result of step 1516 is identical to the representation of FIG. 9 where the outline of the clipping path Z is shown.

Whilst the example of FIGS. 15 to 17 makes reference to the “src_in” operation, the principles discussed above may be used to address problems caused by other ones of the operations. Those operations include:
clear; A; A in B; A rin B; A out B; A ratop B

Accordingly, the arrangement of FIG. 15 requires a composite result buffer (i.e., the main buffer copy U) when used with some conventional drawing systems, as discussed above, in order to support the entire set of Porter & Duff compositing operations. For such conventional drawing systems, the method 1000 as shown in FIG. 10 may be used to avoid the need of a composite result buffer.

### INDUSTRIAL APPLICABILITY

It is apparent from the above that the arrangements described are applicable to the computer graphic and image processing industries.

The foregoing describes only some embodiments of the present invention, and modifications and/or changes can be made thereto without departing from the scope and spirit of the invention, the embodiments being illustrative and not restrictive.

1. A method of compositing a group of graphical objects onto a main buffer using a specified compositing operation, said method comprising the steps of:
forming said group of objects in a temporary buffer;
providing, for each object in said group of objects, a corresponding clipping path;
calculating a resultant clipping path defined by a union of said clipping paths;
compositing said group of objects from said temporary buffer to a main buffer through said resultant clipping path using said specified compositing operation.

2. A method according to claim 1 wherein at least one of said objects has less than 100% opacity.

3. A method according to either of claims 1 or 2 wherein said group of objects has less than 100% opacity.

4. A method according to any of claims 1, 2, or 3, wherein said compositing is performed using a compositing operation selected from the group consisting of.
clear; A; A in B; A rin B; A out B; A ratop B.

5. A method according to any of claims 1, 2, or 3 wherein said forming comprises rendering each of said objects in said group to said temporary buffer.

6. A method according to claim 5 wherein said rendering is performed sequentially and said providing is performed for each said object, as each said object is rendered.

7. A method according to any of claims 1, 2, or 3 wherein said main buffer, prior to said compositing, comprises a rendering of at least one further graphical object.

8. A method according to any of claims 1, 2, or 3 wherein said providing of said clipping path is performed using a path defining said object, where said object defines one of shapes and text.

9. A method according to any of claims 1, 2, or 3 wherein said providing of said clipping path is performed, for a stroked object, by converting the stroked path to a clipping path.

10. A method according to any of claims 1, 2, or 3 wherein said providing of said clipping path is performed, for a bitmap image object, using an edge or extent of the bitmap image object.

11. A method according to any of claims 1, 2, or 3 wherein when one said object is an effect object having a region in which the effect operates, said providing of said clipping path comprises converting the extent of said region to the clipping path.

12. A method according to claim 1, wherein said compositing step comprises the sub-steps of:
compositing said main buffer onto said group of objects in said temporary buffer using a compositing operation that is complementary to said specified compositing operation; copying said temporary buffer onto said main buffer through said resultant clipping path.

13. A method according to claim 1 wherein said compositing step comprises the sub-steps of:
copying said main buffer;
compositing said group of objects from said temporary buffer to said main buffer copy using said specified compositing operation;
copying said main buffer copy onto said main buffer through said resultant clipping path.

14. A method according to claim 1, wherein said objects are opaque and compositing step comprises the sub-steps of:
compositing said group of objects from said temporary buffer to said main buffer using a second compositing operation that is derived from said specified compositing operation.

15. An apparatus for compositing a group of graphical objects, said apparatus comprising:
object forming means for forming said group of objects in a temporary buffer;
clipping path providing means for providing, for each object in said group of objects, a corresponding clipping path;
calculating means for calculating a resultant clipping path defined by a union of said clipping paths;
compositing means for compositing said group of objects from said temporary buffer to a main buffer through said resultant clipping path.

16. A computer readable medium, having a program recorded thereon, where the program is configured to make a computer execute a procedure to composite a group of graphical objects, said method comprising the steps of:
code for forming said group of objects in a temporary buffer;
code for providing, for each object in said group of objects, a corresponding clipping path;
code for calculating a resultant clipping path defined by a union of said clipping paths;
code for compositing said group of objects from said temporary buffer to a main buffer through said resultant clipping path.

17. A computer program for compositing a group of graphical objects, said program comprising:
code for forming said group of objects in a temporary buffer;
code for providing, for each object in said group of objects, a corresponding clipping path;
code for calculating a resultant clipping path defined by a union of said clipping paths;
code for compositing said group of objects from said temporary buffer to a main buffer through said resultant clipping path.

18. A method of compositing a group of graphical objects onto a main buffer using a specified compositing operation, said method comprising the steps of:
forming said group of objects in a temporary buffer;
providing, for each object in said group of objects, a corresponding clipping path;
calculating a resultant clipping path defined by a union of said clipping paths;
compositing said main buffer onto said group of objects in said temporary buffer using a compositing operation that is complementary to said specified compositing operation; and
copying said temporary buffer to said main buffer through said resultant clipping path.

19. A method of compositing an opaque graphical object onto a second opaque graphical object using a specified compositing operation so as to preserve unchanged pixel values outside the boundary of said opaque graphical object, said method comprising at least the step of compositing said opaque graphical object onto said second graphical object using a second compositing operation that is derived from said specified compositing operation.

20. A method according to claim 19 wherein said opaque graphical object is a group comprising a plurality of further opaque graphical objects.

21. A method according to claim 19 wherein said second compositing operation is an ‘rout’ operation if said specified compositing operation is a ‘clear’ operation.

22. A method according to claim 19 wherein said second compositing operation is a ‘over’ operation if said specified compositing operation is a ‘src’ operation.

23. A method according to claim 19 wherein said second compositing operation is an ‘atop’ operation if said specified compositing operation is an ‘in’ operation.

24. A method according to claim 19 wherein said second compositing operation is an ‘dst’ operation if said specified compositing operation is an ‘rin’ operation.

25. A method according to claim 19 wherein said second compositing operation is an ‘xor’ operation if said specified compositing operation is an ‘out’ operation.

26. A method according to claim 19 wherein said second compositing operation is an ‘rover’ operation if said specified compositing operation is an ‘ratop’ operation.

27. An apparatus for compositing a group of graphical objects onto a main buffer using a specified compositing operation, said apparatus comprising:
object forming means for forming said group of objects in a temporary buffer;
clipping path providing means for providing, for each object in said group of objects, a corresponding clipping path;
calculating means for calculating a resultant clipping path defined by a union of said clipping paths;
compositing means for compositing said main buffer onto said group of objects in said temporary buffer using a compositing operation that is complementary to said specified compositing operation; and
copying means for copying said temporary buffer to said main buffer through said resultant clipping path.

28. A computer readable medium, having a program recorded thereon, where the program is configured to make a computer execute a procedure to composite a group of graphical objects onto a main buffer using a specified compositing operation, said program comprising:
code for forming said group of objects in a temporary buffer;
code for providing, for each object in said group of objects, a corresponding clipping path;
code for calculating a resultant clipping path defined by a union of said clipping paths;
code for compositing said main buffer onto said group of objects in said temporary buffer using a compositing operation that is complementary to said specified compositing operation; and
code for copying said temporary buffer to said main buffer through said resultant clipping path.

29. A computer program for compositing a group of graphical objects onto a main buffer using a specified compositing operation, said program comprising:
code for forming said group of objects in a temporary buffer;
code for providing, for each object in said group of objects, a corresponding clipping path;
code for calculating a resultant clipping path defined by a union of said clipping paths;
code for compositing said main buffer onto said group of objects in said temporary buffer using a compositing operation that is complementary to said specified compositing operation; and
code for copying said temporary buffer to said main buffer through said resultant clipping path.

30. A method of compositing a graphical object onto a second graphical object using a specified compositing operation through a clipping path, said method comprising at least the steps of:
compositing said second graphical object onto a buffer containing said graphical object using a second compositing operation that is complementary to said specified compositing operation; and
copying the contents of said buffer onto a second buffer containing said second graphical object through said clipping path.

31. An apparatus for compositing a graphical object onto a second graphical object using a specified compositing operation through a clipping path, said apparatus comprising:
compositing means for compositing said second graphical object onto a buffer containing said graphical object using a second compositing operation that is complementary to said specified compositing operation; and
copying means for copying the contents of said buffer onto a second buffer containing said second graphical object through said clipping path.

32. A computer readable medium, having a program recorded thereon, where the program is configured to make a computer execute a procedure to composite a graphical object onto a second graphical object using a specified compositing operation through a clipping path, said program comprising:
code for compositing said second graphical object onto a buffer containing said graphical object using a second compositing operation that is complementary to said specified compositing operation; and
code for copying the contents of said buffer onto a second buffer containing said second graphical object through said clipping path.

33. A computer program for compositing a graphical object onto a second graphical object using a specified compositing operation through a clipping path, said program comprising:
code for compositing said second graphical object onto a buffer containing said graphical object using a second compositing operation that is complementary to said specified compositing operation; and
code for copying the contents of said buffer onto a second buffer containing said second graphical object through said clipping path.
